(19) United States
(12) Patent Application Publication
(10) Pub. No.: US 2017/0283515 A1
(43) Pub. Date: Oct. 5, 2017

(54) Methods of Preparing Hemicellulose Compositions

(71) Applicant: Kemira Oyj, Helsinki (FI)

(72) Inventors: Xihui Yin, Atlanta, GA (US); Duane C. Wilson, Marietta, GA (US); Stephanie A. Kofsky-Wofford, Marietta, GA (US); Marcelo Moreira da Costa, Ipatinga (BR)

(21) Appl. No.: 15/473,715

(22) Filed: Mar. 30, 2017

Related U.S. Application Data
(60) Provisional application No. 62/316,084, filed on Mar. 31, 2016.

(51) Int. Cl. C08B 37/00; B03D 1/016

(52) U.S. Cl. CPC C08B 37/0057; B03D 1/016; B03D 2201/06; B03D 2201/02; B03D 2203/02

(57) ABSTRACT

Multi-extraction methods for preparing hemicellulose compositions are provided. Depressant compositions comprising hemicellulose compositions are also provided herein. Also disclosed are processes for enriching a desired mineral from an ore comprising the desired mineral, wherein the process comprises carrying out a flotation process in the presence of one or more collecting agents and a depressant composition comprising hemicellulose.

### CROSS-REFERENCE TO RELATED APPLICATION

The application claims priority to U.S. Provisional Patent Application No. 62/316,084, filed Mar. 31, 2016, the entirety of which is incorporated herein.

### FIELD OF THE ART

The present disclosure generally relates to methods of preparing hemicellulose compositions, which can be used as depressants in mineral ore flotation processes.

### BACKGROUND

In the processing of mineral-containing ores, it is desirable to separate undesirable minerals known as gangue (e.g., Al₂O₃, SiO₂ and TiO₂) from the desired minerals in ore (e.g., iron ore). One method of accomplishing this goal is to depress the flotation of a particular mineral during the normal flotation process. In mineral flotation systems, it is common to depress the gangue materials while floating the desirable mineral or minerals. In differential or reverse flotation systems, it is common to depress the desired mineral or minerals while floating the gangue. Depression is conventionally accomplished by the use of one or more depressing agents (also known as depressants) during the flotation step. The depressant, when added to the flotation system, exerts a specific action on the material to be depressed thereby preventing it from floating. The ability of the depressant to facilitate such separation is referred to as its selectivity, i.e., a more selective depressant achieves better separation of the gangue from the desired minerals.

In a typical ore flotation scheme, the ore is ground to a size sufficiently small to liberate the desired mineral or minerals from the gangue. An additional step in the flotation process involves the removal of the ultra-fine particles by desliming. Ultra-fine particles are generally defined as those less than 5 to 10 microns in diameter. The desliming process may be accompanied by or followed by a flocculation step or some other type of settling step such as the use of a cyclone separating device. This step is followed by a flotation step wherein gangue materials are separated from the desired mineral or minerals in the presence of collectors and/or frothers.

It has been conventional in many flotation systems to use naturally derived substances such as starches, dextrins and gums as depressants. In some countries, there is a prohibition against using substances such as starch which have food value in this type of commercial application.

Corn fiber is a low value byproduct of the corn milling process that is commonly blended with steep liquor and used as animal feed. The major components of corn fiber are cellulose, hemicellulose, protein, oil, lignin and starch. Hemicellulose is typically isolated from corn fiber by an alkaline hydrogen peroxide process (AHP). In AHP, corn fiber is mixed with alkaline solution and peroxide at high temperature. The resulting product contains a solid and liquid portion. The solid portion is separated from the liquid as the liquid contains the hemicellulose. This method is cumbersome as the dissolved organic solid content is low and only from about 50-75% of the corn fiber dissolves in the reaction medium. Concentration methods to increase the dissolved organic solid content have proved unsuccessful as the corn fiber swells significantly under the extraction conditions, thereby increasing amount of corn fiber in the extraction solution (referred to as “consistency %”) and resulting in high slurry viscosities and ineffective solid-liquid separations, leading to a loss of product. Vacuum evaporation of the hemicellulose solution was also unsuccessful due to significant foaming.

### BRIEF SUMMARY

Disclosed herein are compositions comprising hemicellulose, and methods for preparing the compositions, and their use as depressant compositions in mineral ore flotation. In particular, a method for preparing a hemicellulose composition, or a depressant composition comprising hemicellulose, comprises:
(a) combining new or undigested plant material comprising hemicellulose, at least one caustic base and, optionally, at least one oxidant to form a first reaction mixture;
(b) reacting the first reaction mixture for a time sufficient to form a first reaction product containing hemicellulose, wherein the reaction product comprises a liquid portion and solid portion;
(c) separating at least some of the liquid portion of the first reaction product from the solid portion of the first reaction product to provide a first hemicellulose composition;
(d) combining at least a portion of the first hemicellulose composition with new or undigested plant material, at least one caustic base and, optionally, at least one oxidant to form a second reaction mixture,
(e) reacting the second reaction mixture for a time sufficient to form a second reaction product containing hemicellulose, wherein the reaction product comprises a liquid portion and a solid portion;
(f) separating at least some of the liquid portion of the second reaction product from the solid portion of the second reaction product to provide a second hemicellulose composition or depressant composition comprising hemicellulose.

Also disclosed are processes for enriching a desired mineral from an ore comprising the desired mineral, wherein the process comprises carrying out a flotation process in the presence of one or more collecting agents and an exemplary hemicellulose composition described herein or a depressant composition comprising hemicellulose.

The disclosure may be understood more readily by reference to the following detailed description of the various features of the disclosure and the examples included therein.

### BRIEF DESCRIPTION OF FIGURES

FIG. 1 is a flowchart illustrating an exemplary process.

FIG. 2 is a graph of iron recovery (Fe recovery %) vs. silica float for iron ore flotation processes which utilized a stage 1 extraction hemicellulose composition as the depressant, an exemplary (stage 3 extraction) hemicellulose composition as the depressant, or no depressant.

### DETAILED DESCRIPTION

### Definitions

As used herein, “hemicellulose” refers to the heteropolymer polysaccharide components of plant cell walls other than cellulose. Hemicelluloses have sugars called pentoses such as xylose, each having five carbon atoms as constituent units, sugars called hexoses such as mannose, arabinose and galacturonic acid, each having six carbon atoms as constituent units, and optionally complex polysaccharides such as glucomannan and glucuronoxylan. Hemicellulose can be any of several heteropolymers present in almost all plant cell walls, e.g., xylan, arabinoxylan, glucuronoxylan, glucuronoarabinoxylan. Typically, the main chain (i.e., backbone) is composed of β-1,4-linked D-xylopyranose residues. Besides xylose, hemicelluloses may contain arabinose, glucuronic acid or its 4-O-methyl ether, and acetic, ferulic, and p-coumaric acids. In some cases, the monomers branch off the xylan backbone. The frequency and composition of branches are dependent on the source. All types of hemicellulose may be used in the exemplary embodiments.

As used herein, a “depressant” refers to an agent that depresses the flotation of the desired minerals in preference to depressing the flotation of the associated gangue.

As used herein, the “desired minerals” refers to minerals which have value and may be extracted from ore which contains the desired mineral and gangue. Examples of desired minerals include iron powder, hematite, magnetite, pyrite, chromite, goethite, marcasite, limonite, pyrrohotite or any other iron-containing minerals.

As used herein, “gangue” refers to the undesirable minerals in a material that contains both undesirable and desired minerals, for example an ore deposit. Such undesirable minerals may include oxides of aluminum, silica (e.g., quartz), titanium, sulfur and alkaline earth metals. In certain embodiments, the gangue includes oxides of silica, silicates or siliceous materials.

As used herein, “ore” refers to rocks and deposits from which the desired minerals can be extracted. Other sources of the desired minerals may be included in the definition of “ore” depending on the identity of the desired mineral. The ore may contain undesirable minerals or materials, also referred to herein as gangue.

As used herein, “iron ore” refers to rocks, minerals and other sources of iron from which metallic iron can be extracted. The ores are usually rich in iron oxides and vary in color from dark grey, bright yellow, deep purple, to rusty red. The iron itself is usually found in the form of magnetite (Fe₃O₄), hematite (Fe₂O₃), goethite (FeO(OH)), limonite (FeO(OH).n(H₂O)), siderite (FeCO₃) or pyrite (FeS₂). Taconite is an iron-bearing sedimentary rock in which the iron minerals are interlayered with quartz, chert, or carbonate. Itabirite, also known as banded-quartz hematite and hematite schist, is an iron and quartz formation in which the iron is present as thin layers of hematite, magnetite, or martite. Any of these types of iron are suitable for use in processes described herein. In exemplary embodiments, the iron ore is substantially magnetite, hematite, taconite or itabirite. In exemplary embodiments, the iron ore is substantially pyrite. In exemplary embodiments, the iron ore is contaminated with gangue materials, for example oxides of aluminum, silica or titanium. In exemplary embodiments, the iron ore is contaminated with clay.

Method of Preparing Hemicellulose Compositions

In exemplary embodiments, a method of preparing a hemicellulose composition from plant material comprising hemicellulose via a multi-extraction method is provided. In exemplary embodiments, the multi-extraction method comprises a first extraction of plant material comprising hemicellulose to form a reaction product containing hemicellulose, e.g., a solution containing hemicellulose and plant material waste solids; separation of the solution containing hemicellulose from the plant material waste solids; and a second extraction wherein of plant material comprising hemicellulose wherein at least a portion of the solution containing hemicellulose produced from the first extraction is added to new plant material at least one caustic and, optionally, at least one oxidant, i.e., to extract hemicellulose from the new plant material. At least a portion of the solution containing hemicellulose can be separated from the plant material waste solids and, optionally, used in a third extraction wherein another portion of new plant material at least one caustic and, optionally, at least one oxidant is added. After the desired number of extractions have been completed, the solution containing hemicellulose can be isolated, i.e., separated from the plant material waste solids, and used as desired, for example as a depressant composition. This method can be used advantageously to achieve compositions having a high concentration of hemicellulose.

In exemplary embodiments, in each stage of the method, i.e., each extraction, plant material comprising hemicellulose, at least one caustic and, optionally, at least one oxidant are combined to provide a reaction mixture; the reaction mixture is allowed to react for a period of time to facilitate digestion of the plant material and production of a reaction product containing hemicellulose and a hemicellulose composition is separated from the reaction product. Optionally, the reaction or digestion step may further comprise heating, mixing, stirring, sonicating, and/or agitating the reaction mixture. In each extraction, a solvent, for example water, may be added as desired. In certain exemplary embodiments, water is added to the reaction mixture to form a flowable slurry in the first extraction. High plant material content is desirable; however, any concentration could work.

In exemplary embodiments, after the reaction or digestion step, at least a portion of the hemicellulose composition, which is a solution, is separated from the plant material solid waste and carried on to the next stage of the method, i.e., the next extraction. In next stage, at least a portion of the hemicellulose composition of the previous stage is combined with additional (new or undigested) plant material, at least one caustic and, optionally, at least one oxidant. The reaction mixture is allowed to react for a period of time to form another reaction product. A hemicellulose composition, which is a solution, is separated from the reaction product. In exemplary embodiments, the hemicellulose composition from a respective stage can be carried on to one or more subsequent stages for extraction of new or undigested plant material to produce a hemicellulose composition having a desired hemicellulose content. In certain exemplary embodiments, the hemicellulose composition after the final separation is referred to herein as the “depressant composition.”

In exemplary embodiments, the hemicellulose content of hemicellulose composition and/or depressant composition can be increased by washing the plant material solid waste of the reaction product. For example, a small amount of water can be added to the plant material solid waste and then at least a portion of the resulting solution referred to herein as the “hemicellulose wash composition,” can be removed or separated from the plant material solid waste, optionally diluted, and added to the hemicellulose composition. Such hemicellulose composition may be carried on to the next extraction or used as desired, for example as a depressant composition.

Accordingly, in certain exemplary embodiments, a method for preparing a hemicellulose composition or a depressant composition comprising hemicellulose comprises:
(a) combining new or undigested plant material, at least one caustic base and, optionally, at least one oxidant to form a first reaction mixture;
(b) reacting the first reaction mixture for a time sufficient to form a first reaction product containing hemicellulose, wherein the reaction product comprises a liquid portion and solid portion;
(c) separating at least some of the liquid portion of the first reaction product from the solid portion of the first reaction product to provide a first hemicellulose composition;
(d) combining at least a portion of the first hemicellulose composition with new or undigested plant material, at least one caustic base and, optionally, at least one oxidant to form a second reaction mixture,
(e) reacting the second reaction mixture for a time sufficient to form a second reaction product containing hemicellulose, wherein the reaction product comprises a liquid portion and solid portion;
(f) separating at least some of the liquid portion of the second reaction product from the solid portion of the second reaction product to provide a second hemicellulose composition or a depressant composition comprising hemicellulose.

In certain exemplary embodiments, the reacting steps, for example steps (b) and/or (e), can each independently further comprise heating the reaction mixture. In certain exemplary embodiments, the reacting steps, for example steps (b) and/or (e), can each independently further comprise mixing, stirring, agitating and/or sonicating the reaction mixture.

In certain exemplary embodiments, the method further comprises:
(g) combining at least a portion of the second hemicellulose composition with new or undigested plant material, at least one caustic base and, optionally, at least one oxidant to form a third reaction mixture,
(h) reacting the third reaction reacting mixture for a time sufficient to form a third reaction product containing hemicellulose; wherein the reaction product comprises a liquid portion and solid portion; and
(i) separating at least some of the liquid portion of the third reaction product from the solid portion of the third reaction product to provide a third hemicellulose composition or a depressant composition comprising hemicellulose.

In certain exemplary embodiments, the reacting step (h) further comprises heating the reaction mixture. In certain exemplary embodiments, the reacting step (h) further comprises mixing, stirring, agitating or sonicating the reaction mixture.

In certain exemplary embodiments, a method for preparing a hemicellulose composition or a depressant composition comprising hemicellulose comprises:
(a) combining new or undigested plant material, at least one caustic base and, optionally, at least one oxidant to form a first reaction mixture;
(b) reacting the first reaction mixture for a time sufficient to form a first reaction product containing hemicellulose, wherein the reaction product comprises a liquid portion and solid portion;
(c) separating at least some of the liquid portion of the first reaction product from the solid portion of the first reaction product to provide a first hemicellulose composition;
(d) combining at least a portion of the first hemicellulose composition with new or undigested plant material, at least one caustic base and, optionally, at least one oxidant to form a second reaction mixture,
(e) reacting the second reaction mixture for a time sufficient to form a second reaction product containing hemicellulose, wherein the reaction product comprises a liquid portion and solid portion;
(f) separating at least some of the liquid portion of the second reaction product from the solid portion of the second reaction product to provide a second hemicellulose composition;
(g) combining at least a portion of the second hemicellulose composition with new or undigested plant material, at least one caustic base and, optionally, at least one oxidant to form a third reaction mixture,
(h) reacting the third reaction reacting mixture for a time sufficient to form a third reaction product containing hemicellulose; wherein the reaction product comprises a liquid portion and solid portion; and
(i) separating at least some of the liquid portion of the third reaction product from the solid portion of the third reaction product to provide a third hemicellulose composition or a depressant composition comprising hemicellulose.

In certain exemplary embodiments, the method further comprises:
(j) combining at least a portion of the third hemicellulose composition with new or undigested plant material, at least one caustic base and, optionally, at least one oxidant to form a fourth reaction mixture,
(k) reacting the fourth reaction reacting mixture for a time sufficient to form a fourth reaction product containing hemicellulose; wherein the reaction product comprises a liquid portion and solid portion; and
(l) separating at least some of the liquid portion of the fourth reaction product from the solid portion of the fourth reaction product to provide a fourth hemicellulose composition or a depressant composition comprising hemicellulose.

In certain exemplary embodiments, the reacting step (k) further comprises heating the reaction mixture. In certain exemplary embodiments, the reacting step (k) further comprises mixing, stirring, agitating or sonicating the reaction mixture.

In certain exemplary embodiments, a method for preparing a hemicellulose composition or a depressant composition comprising hemicellulose comprises:
(a) combining new or undigested plant material, at least one caustic base and, optionally, at least one oxidant to form a first reaction mixture;
(b) reacting the first reaction mixture for a time sufficient to form a first reaction product containing hemicellulose, wherein the reaction product comprises a liquid portion and solid portion;
(c) separating at least some of the liquid portion of the first reaction product from the solid portion of the first reaction product to provide a first hemicellulose composition;
(d) combining at least a portion of the first hemicellulose composition with new or undigested plant material, at least one caustic base and, optionally, at least one oxidant to form a second reaction mixture,
(e) reacting the second reaction mixture for a time sufficient to form a second reaction product containing hemicellulose, wherein the reaction product comprises a liquid portion and solid portion;
(f) separating at least some of the liquid portion of the second reaction product from the solid portion of the second reaction product to provide a second hemicellulose composition;
(g) combining at least a portion of the second hemicellulose composition with new or undigested plant material, at least one caustic base and, optionally, at least one oxidant to form a third reaction mixture,
(h) reacting the third reaction mixture for a time sufficient to form a third reaction product containing hemicellulose; wherein the reaction product comprises a liquid portion and solid portion; and
(i) separating at least some of the liquid portion of the third reaction product from the solid portion of the third reaction product to provide a fourth hemicellulose composition;
(j) combining at least a portion of the fourth hemicellulose composition with new or undigested plant material, at least one caustic base and, optionally, at least one oxidant to form a fourth reaction mixture,
(k) reacting the fourth reaction mixture for a time sufficient to form a fourth reaction product containing hemicellulose; wherein the reaction product comprises a liquid portion and solid portion; and
(l) separating at least some of the liquid portion of the fourth reaction product from the solid portion of the fourth reaction product to provide a fourth hemicellulose composition or a depressant composition comprising hemicellulose.

Hemicellulose is found in almost all plant cell walls. Accordingly, any plant material comprising hemicellulose can be used in the present method. In each stage, the plant material can comprise one type of plant material or a combination of plant materials.

In exemplary embodiments, the plant material is any type of lignocellulosic biomass. Exemplary lignocellulosic biomass sources include, but are not limited to, agricultural residues (e.g., corn stover and wheat straw), hardwoods (e.g., aspenwood) and herbaceous crops (e.g., switchgrass). In a particular embodiment, the plant material is a waste product of industrial processing. Generally, in each of the combining steps of the methods described herein, the plant material is new material or material which has not been digested, for example digested with at least one caustic base and, optionally, at least one oxidant. In certain exemplary embodiments, the new or undigested plant material is ground to a desired size before use in the exemplary methods. In certain exemplary embodiments, the new or undigested plant material is not ground before use in the exemplary methods. In certain exemplary embodiments, the new or undigested plant material is treated with an agent that will enhance the extraction or digestion process, for example the plant material is soaked in an oxidant solution or enzyme solution prior to use in the exemplary methods. In certain exemplary embodiments, the new or undigested plant material is washed, for example with water and/or organic solvents, before use in the exemplary methods. In certain exemplary embodiments, the new or undigested plant material is not washed before use in the exemplary methods. In certain exemplary embodiments, the new or undigested plant material is destarched before use in the exemplary methods. In certain exemplary embodiments, the new or undigested plant material is not destarched before use in the exemplary methods.

Exemplary plant materials include, but are not limited to, sugarcane bagasse, wheat straw, corn stover (which may include the stalk, leaves, husk and cob of the corn plant), corn fiber (or corn bran, or corn hull), switch grass, pine wood, aspen wood and spruce wood. In certain exemplary embodiments, the plant material is selected from corn fiber, corn stover and mixtures thereof. In certain exemplary embodiments, the plant material comprises or consists essentially of corn fiber, corn stover and mixtures thereof. In certain exemplary embodiments, the plant material is corn fiber. In certain exemplary embodiments, the plant material comprises, or consists essentially of, corn fiber. In certain exemplary embodiments, the plant material is corn stover. In certain exemplary embodiments, the plant material comprises or consists essentially of corn stover.

Corn fiber comprises a matrix of hemicellulose, cellulose, and lignin. Any corn fiber may be used in the present method, including native corn fiber and corn fiber produced by standard breeding techniques including crossbreeding, translocation, inversion, transformation or any other method of gene or chromosome engineering to include variations thereof. Native corn is intended to mean those varieties found in nature, including dent, waxy, or high amylose corn.

In exemplary embodiments, the corn fiber can be obtained from a wet-milling or a dry-milling process. Accordingly, the corn fiber can be wet or dry. In embodiments, the corn fiber can be dried and stored prior to use in the present method.

The corn fiber can be de-starched corn-fiber. De-starched corn fiber is typically formed by liquefying corn fiber with α-amylase until at least part is soluble. Other methods of destarching known in the art are also suitable, including separation of the starch from the fiber, i.e., by a hydrocyclone, or by use of other enzyme(s) or combinations thereof.

The consistency % of the plant material, e.g., corn fiber, refers to the percent of plant material in the reaction mixture, e.g., the extraction solution. The consistency % includes both the amount of solid plant material added (e.g., dry corn fiber) and, if applicable, the amount of plant material in the hemicellulose composition and/or hemicellulose wash composition from a prior stage.

In exemplary embodiments, the plant material consistency may be the same or different in each reaction mixture in the process. In exemplary embodiments, the reaction mixture has a plant material consistency % of from about 5% to about 50%, about 5% to about 40%, about 5% to about 30%, about 5% to about 20%, about 5% to about 15%, about 5% to about 10% or from about 10% to about 15%. In more particular embodiments, the reaction mixture, for example the first reaction mixture, has a plant material consistency % of about 5%, about 6%, about 7%, about 8%, about 9%, about 10%, about 11%, about 12%, about 13%, about 14% or about 15%. In more particular embodiments, the reaction mixture, for example the second reaction mixture, has a plant material consistency % of about 12%, about 13%, about 14%, about 15%, about 16%, about 17%, about 18%, about 19%, about 20%, about 21% or about 22%. In more particular embodiments, the reaction mixture, for example the third reaction mixture, has a plant material consistency % of about 18%, about 19%, about 20%, about 21%, about 22%, about 23%, about 24%, about 25%, about 26%, about 27% or about 28%. In a particular embodiment, the plant material consistency % is about 10%. In a particular embodiment, the plant material consistency % derived from the new, solid plant material is about 10%.

In exemplary embodiments, the reaction mixture has a corn fiber consistency % from about 5% to about 15%, such as, for example, from about 5% to about 10% or from about 10% to about 15%. In more particular embodiments, the reaction mixture has a corn fiber consistency of about 5%, about 6%, about 7%, about 8%, about 9%, about 10%, about 11%, about 12%, about 13%, about 14% or about 15%. In a particular embodiment, the corn fiber consistency % is about 10%.

In certain exemplary embodiments, the reaction mixture resulting from the first extraction comprises about 500 mL to about 800 mL liquid portion and about 500 g to about 200 g solid portion (e.g., solid waste plant material). In certain exemplary embodiments, the proportion of milliliters of liquid portion to grams of solid portion in the reaction mixture is in the range of about 1:1 mL:g to about 4:1 mL:g.

Any caustic base or combination of caustic bases can be used in the exemplary methods. Exemplary caustic bases include, but are not limited to, sodium hydroxide, calcium hydroxide, potassium hydroxide, lithium hydroxide, rubidium hydroxide, cesium hydroxide, magnesium hydroxide, strontium hydroxide, barium hydroxide, calcium hydroxide, a hydrate thereof, an oxide thereof, or a combination thereof. In exemplary embodiments, the at least one caustic base comprises, or consists essentially of, sodium hydroxide. In certain embodiments, the at least one caustic base does not comprise calcium hydroxide.

The amount of caustic base used in the reaction mixture can vary. For example, it may be determined, at least in part, on the desired result. In exemplary embodiments, the caustic base is present in an amount from about 50 kg caustic base/ton of dry plant material (e.g., corn fiber) to about 250 kg caustic base/ton of dry plant material, such as, for example, from about 50 kg/ton to about 240 kg/ton, from about 50 kg/ton to about 160 kg/ton, from about 50 kg/ton to about 150 kg/ton, from about 50 kg/ton to about 100 kg/ton, from about 50 kg/ton to about 80 kg/ton, from about 75 kg/ton to about 150 kg/ton, from about 75 kg/ton to about 140 kg/ton, from about 75 kg/ton to about 130 kg/ton, from about 75 kg/ton to about 120 kg/ton, from about 75 kg/ton to about 100 kg/ton, from about 100 kg/ton to about 150 kg/ton or from about 120 kg/ton to about 150 kg/ton. In exemplary embodiments, from about 75 kg/ton to about 95 kg/ton, or about 85 kg/ton, is used in the reaction mixture. In exemplary embodiments, the caustic base is NaOH and is present in an amount from about 50 kg NaOH/ton of dry plant material (e.g., corn fiber) to about 250 kg NaOH/ton of dry plant material, or the caustic base is a base other than NaOH, or a mixture of caustic bases, and the molar equivalent of the caustic base or mixture of caustic bases is used.

In exemplary embodiments, the method comprises adding at least one oxidant in at least one of the steps. In exemplary embodiments, the method comprises adding at least one oxidant in every step wherein new or dry plant material is added. Any oxidant or combination of oxidants can be used in the present methods. In exemplary embodiments, the oxidant comprises at least one peroxide. Suitable peroxides include inorganic peroxides and organic peroxides. Exemplary inorganic peroxides include, but are not limited to, bleach (sodium hypochlorite), hydrogen peroxide, sodium peroxide, sodium perborate, sodium percarbonate, sodium persulfate, zinc oxide, barium peroxide and strontium peroxide. Exemplary organic peroxides include, but are not limited to, alkyl hydroperoxides, aryl hydroperoxides, dialkyl peroxides, acyl peroxides, polyperoxides, peroxyesters, allkylidine peroxides, percarboxylic acids and cyclic peroxides.

Other suitable oxidants, or compounds that could produce an oxidant species in the reaction, include ozone, nitric acid, peroxydisulfuric acid, peroxymonosulfuric acid, chlorite, chlorate, perchlorate, hypochlorite, sodium hypochlorite, calcium hypochlorite, hexavalent chromium compounds (e.g., chromic and dichromic acids, chromium trioxide, pyridium chlorochromate), permanganate, nitrous oxide and potassium nitrate.

In exemplary embodiments, the amount of oxidant used in the reaction mixture can vary. For example, it may be determined, at least in part, on the desired result. In certain exemplary embodiments, in at least one of the steps wherein dry or new plant material is added, no oxidant is added. In certain exemplary embodiments, no oxidants are used in the method.

In exemplary embodiments, the oxidant is present in an amount from about 0.1 kg oxidant/ton to about 100 kg oxidant/ton of dry, new plant material (e.g., corn fiber), from 15 kg/ton to about 100 kg/ton, from 20 kg/ton to about 60 kg/ton, about 20 kg/ton to about 50 kg/ton, about 20 kg/ton to about 40 kg/ton, about 20 kg/ton to about 30 kg/ton, about 30 kg/ton to about 50 kg/ton, about 30 kg/ton to about 40 kg/ton, or about 40 kg/ton to about 50 kg/ton. In exemplary embodiments, the oxidant is H₂O₂ and is present in an amount from about 0.1 kg H₂O₂/ton of dry plant material (e.g., corn fiber) to about 100 kg H₂O₂/ton of dry plant material, or the oxidant is an oxidant other than H₂O₂, or a mixture of oxidants, and the molar equivalent of the oxidant, or mixture of oxidants, is used.

In certain exemplary embodiments, the oxidant is hydrogen peroxide and is present in an amount from about 0.1 kg/ton e.g., to about 100 kg/ton of dry, new plant material (e.g., corn fiber), from 15 kg/ton to about 100 kg/ton, from 20 kg/ton to about 60 kg/ton, about 20 kg/ton to about 50 kg/ton, about 20 kg/ton to about 40 kg/ton, about 20 kg/ton to about 30 kg/ton, about 30 kg/ton to about 50 kg/ton, about 30 kg/ton to about 40 kg/ton, or about 40 kg/ton to about 50 kg/ton. In exemplary embodiments, from about 25 kg/ton to about 35 kg/ton, or about 30 kg/ton, of hydrogen peroxide is used in the reaction mixture.

In exemplary embodiments, once the reaction mixture (typically a slurry) comprising plant material, at least one caustic base and, optionally, at least one oxidant, is prepared, the reaction mixture is heated. In exemplary embodiments, the method degrades the plant material into its constituent components, such as organic solids including hemicellulose, lignin, fatty acids and proteins. Depending on the source of plant material, residual starch or other solids may also be present in the organic solids.

In exemplary embodiments, the reaction mixture can be heated at temperatures form about 25° C. to about 200° C., about 25° C. to about 150° C., about 25° C. to about 130° C., from about 25° C. to about 100° C., from about 25° C. to about 75° C., from about 25° C. to about 50° C., from about 50° C. to about 130° C., from about 50° C. to about 100° C., from about 50° C. to about 75° C., from about 75° C. to about 130° C., from about 75° C. to about 100° C. and from about 100° C. to about 130° C. In exemplary embodiments, the reaction mixture is heated to a temperature between about 70° C. and about 90° C., or about 80° C.

In exemplary embodiments, the reaction is carried out at about ambient pressure. In exemplary embodiments, the reaction is carried out at a pressure higher than ambient pressure.

In exemplary embodiments, the amount of time that the reaction mixture is heated can vary, and may be determined, for example, by the heating temperature, the type and amount of plant material, the caustic base and/or the oxidant. In exemplary embodiments, the reaction mixture is heated from about 15 minutes to about 72 hours, about 15 minutes to about 36 hours, from about 15 minutes to about 24 hours, from about 15 minutes to about 12 hours, from about 15 minutes to about 6 hours, from about 15 minutes to about 3 hours, from about 1 hour to about 36 hours, from about 1 hour to about 24 hours, from about 1 hour to about 12 hours, from about 1 hour to about 6 hours, from about 1 hour to about 3 hours, from about 3 hours to about 36 hours, from about 3 hours to about 24 hours, from about 3 hours to about 12 hours, from about 3 hours to about 6 hours, from about 6 hours to about 36 hours, from about 6 hours to about 24 hours, from about 6 hours to about 12 hours, from about 12 hours to about 36 hours, from about 12 hours to about 24 hours or from about 24 hours to about 36 hours. In a particular embodiment, the reaction mixture is heated for about 30 minutes to about 4 hours, or about 2 hours.

In certain exemplary embodiments, the reaction mixture is mixed by any known mixing technique, for example, stirred, agitated and/or sonicated. In certain exemplary embodiments, the reaction it is not actively mixed, stirred, agitated or sonicated.

In exemplary embodiments, after heating, the reaction product is cooled, for example to a temperature in the range of about 20 to about 25° C., or about ambient temperature.

In exemplary embodiments, the reaction product contains a liquid portion (referred to herein as the “hemicellulose composition”) that contains the majority of the hemicellulose and a solid portion containing plant material (e.g., corn fiber) waste and a minor amount of hemicellulose. The liquid portion can be separated from the solid portion by any means, or multiple means, to provide the hemicellulose composition including, but not limited to, filtration such as gravimetric, filter press, horizontal plate, tubular, and vacuum filtration; centrifugation such as horizontal decanter and high speed disc centrifugation; microfiltration and ultrafiltration.

In exemplary embodiments, the hemicellulose composition is basic. In exemplary embodiments, the pH of the hemicellulose composition is from about 8 to about 14, such as, for example, from about 8 to about 10 or about 10 to about 12. In certain embodiments, the pH of the hemicellulose composition is about 8, about 9, about 10, about 11, about 12, about 13 or about 14.

In exemplary embodiments, after removing the solid plant material waste portion, at least a portion of the hemicellulose composition can be carried on to a subsequent extraction. In exemplary embodiments, at least a portion of the hemicellulose composition is combined with dry or new plant material, at least one caustic base and, optionally, at least one oxidant. The plant material consistency %, amount of caustic base and amount of oxidant used in the second or subsequent extraction can be the same or different as the previous extraction. Similarly, the reaction time, the heating temperature, mixing technique, and separation technique in each subsequent extraction can be the same or different as the previous extraction. Again, at least a portion of the resulting hemicellulose composition can be carried on to further subsequent extractions. The last extraction step provides a hemicellulose-containing composition that can be used as a depressant composition.

The number of extractions performed in the method described herein can vary. It may be determined, at least in part, on the desired result. Each sequential, or subsequent, extraction yields more hemicellulose content. However, each extraction can increase the cost of reagents, time and loss of solids. One should consider all aspects of the extraction stages to determine the desirable amount of stages for a method. In exemplary embodiments, the present method contains at least two extraction stages, where one extraction is characterized by a combining, reacting and separating step, wherein some or all of the liquid portion of the first or initial extraction is used in the second or subsequent extraction and the second or subsequent extraction requires the addition of new or undigested plant material. Further extractions may be carried out as desired, wherein the some or all of the liquid portion of the prior extraction is used in the subsequent extraction and the subsequent extraction requires the addition of new or undigested plant material. In exemplary embodiments, the present method contains at least two extractions, where one extraction is characterized by a combining, reacting and separating step; wherein the combining step includes the addition of new or undigested plant material to the reaction mixture. In some embodiments, the method contains at least three extractions, at least four extractions, at least five extractions or at least six extractions.

In exemplary embodiments, one extraction is characterized by a combining, reacting and separating step; wherein the combining step includes the addition of new or undigested plant material to the reaction mixture. The present method contains multiple extraction stages, where the subsequent stage can be accomplished by recycling any hemicellulose composition, in whole or in part, into any extraction. In some exemplary embodiments, the solid plant material (e.g., corn fiber) waste portion is washed to provide a hemicellulose wash composition. Washing can be used to dislodge additional hemicellulose from the solid plant material waste and adds to the hemicellulose content of each extraction. Any suitable solvent can be used for the wash process. In one embodiment, water is used for the wash. In exemplary embodiments, the hemicellulose wash composition and hemicellulose composition are, optionally, both then carried on to the next extraction, or recycled to the same or a previous extraction.

In exemplary embodiments, each extraction, independently yields organic solids comprising hemicellulose, lignin, fatty acids and proteins. In exemplary embodiments, each extraction, independently yields an additional about 2 to about 10 wt % organic solids, comprising hemicellulose, lignin, fatty acids and proteins such as, for example, at least about 3, at least about 4, at least about 5, at least about 6, at least about 7, at least about 8, at least about 9 or at least about 10 wt % organic solids comprising hemicellulose, lignin, fatty acids and proteins. In exemplary embodiments, each extraction yields about 7 wt % organic solids comprising hemicellulose, lignin, fatty acids and proteins.

In exemplary embodiments, the hemicellulose composition of a first extraction contains about 2 to about 10 wt %, or about 5 to about 10 wt %, organic solids comprising hemicellulose, lignin, fatty acids and proteins. In exemplary embodiments, the hemicellulose composition of a second extraction contains from about 4 to about 15 wt %, or about 10 to about 15 wt %, organic solids comprising hemicellulose, lignin, fatty acids and proteins. In exemplary embodiments, the hemicellulose composition of a third extraction contains about 6 to about 30 wt %, or about 20 to about 30 wt %, organic solids comprising hemicellulose, lignin, fatty acids and proteins. In exemplary embodiments, the hemicellulose composition of a fourth extraction contains about 8 to about 30 wt %, or about 21 to about 30 wt %, organic solids comprising hemicellulose, lignin, fatty acids and proteins. In certain exemplary embodiments, the hemicellulose composition of a first extraction contains about 6 to about 8 wt % organic solids comprising hemicellulose, lignin, fatty acids and proteins. In certain exemplary embodiments, the hemicellulose composition of a second extraction contains from about 13 to about 15 wt % organic solids comprising hemicellulose, lignin, fatty acids and proteins. In certain exemplary embodiments, the hemicellulose composition of a third extraction contains about 20 to about 22 wt % organic solids comprising hemicellulose, lignin, fatty acids and proteins. In certain exemplary embodiments, the hemicellulose composition of a fourth extraction contains about 24 to about 26 wt % organic solids comprising hemicellulose, lignin, fatty acids and proteins.

In exemplary embodiments, the hemicellulose in the exemplary hemicellulose composition or exemplary depressant composition may have any molecular weight, or a mixture of molecular weights, so long as the depressant composition has the effect of depressing the flotation of the desired minerals in preference to depressing the flotation of the associated gangue. In exemplary embodiments, the weight average molecular weight of the hemicellulose in the composition is about 100 kDa, about 200 kDa, about 300 kDa, about 400 kDa, or about 500 kDa.

In exemplary embodiments, the weight average molecular weight of the hemicellulose in the composition is in the range of about 50 to about 1,000,000 kDa, about 100 to about 500,000 kDa, about 100 to about 10,000 kDa, about 100 to about 1,000 kDa, about 100 to about 600 kDa.

In one embodiment, the hemicellulose composition is in the form of a liquid. In another embodiment, the hemicellulose composition is in the form of a gel. In a more particular embodiment, the hemicellulose composition is in the form of a water-soluble gel.

Depressant Compositions

The hemicellulose compositions resulting from the exemplary methods can be used as depressants, or depressant compositions, which can be useful in mineral flotation. In particular, the depressant compositions are effective in selectively depressing the flotation of desired mineral(s). In exemplary embodiments, the depressant compositions are used to enhance the separation of iron-containing minerals, such as iron oxides or iron powder, from silicate gangue by differentially depressing the flotation of the iron-containing minerals relative to that of the silicate gangue. One of the problems associated with the separation of iron-containing minerals from silicate gangue is that the iron-containing minerals and silicates both tend to float under certain processing conditions. In exemplary embodiments, the depressant compositions described herein can be used to change the flotation characteristics of the iron-containing minerals relative to silicate gangue, to improve the separation process. In exemplary embodiments, a process for enriching a desired mineral from an ore comprising the desired mineral and gangue comprises carrying out a flotation process in the presence of one or more collecting agents and one or more depressants, wherein at least one of the one or more depressants comprises a hemicellulose composition according to the embodiments described herein. In exemplary embodiments, a process for enriching a desired mineral from an ore comprising the desired mineral and gangue comprises carrying out a flotation process in the presence of one or more collecting agents and one or more depressants, wherein at least one of the one or more depressants comprises a hemicellulose composition comprising at least about 20 wt % organic solids including hemicellulose, lignin, fatty acids and proteins, wherein the weight average molecular weight of the hemicellulose in the depressant composition is from about 100 kDa to about 600 kDa.

In exemplary embodiments, a depressant composition comprises hemicellulose composition resulting from the exemplary methods, and optionally, a solvent. In exemplary embodiments, a solvent may be added to a hemicellulose composition resulting from the exemplary methods. Exemplary depressant compositions are prepared by the methods described herein. In exemplary embodiments, the solvent is water.

In one embodiment, the depressant composition is in the form of a liquid. In another embodiment, the depressant composition is in the form of a gel. In another embodiment, the depressant composition is in the form of a solid. In a more particular embodiment, the depressant composition is in the form of a water-soluble gel.

In exemplary embodiments, the depressant composition may be formulated to provide a sufficient amount of depressant to a flotation process, i.e., an amount sufficient to produce a desired result.

In exemplary embodiments, the depressant composition can include one or more depressants in addition to the exemplary hemicellulose composition. Suitable depressants include, but are not limited to: starch; starch activated by treatment with alkali; cellulose esters, such as carboxymethylcellulose and sulphomethylcellulose; cellulose ethers, such as methyl cellulose, hydroxyethylcellulose and ethyl hydroxyethylcellulose; hydrophilic gums, such as gum arabic, gum karaya, gum tragacanth and gum ghatti, alginates; starch derivatives, such as carboxymethyl starch and phosphate starch; and combinations thereof.

In exemplary embodiments, the depressant composition may also include one or more agents or modifiers. Examples of such agents or modifiers include, but are not limited to, frothers, activators, collecting agents, depressants, dispersants, acidic or basic addition agents, or any other agent known in the art.

In exemplary embodiments, the amount of depressant composition to be used is that which will depress the flotation of the desired mineral ore or ores to a necessary or desired extent. The amount of depressant composition may be determined, for example, based on a number of factors such as the desired mineral and gangue to be separated and the conditions of the flotation process. In exemplary embodiments, the amount of depressant composition used in the flotation process is about 0.01 to about 1.5 kilogram, or about 0.2 to about 0.7 kg of depressant composition per metric ton of ore to be floated. In exemplary embodiments, the specific consumption of depressant composition in the processes is about 0.01 to about 1.5 kilogram, or about 0.2 to about 0.7 kg of depressant composition per metric ton of ore to be floated.

The amount of depression achieved with the depressant composition may be quantified. For example, a percent of depression may be calculated by measuring the weight percent of the particular mineral or gangue floated in the absence of any depressant and measuring the weight percent of the same mineral or gangue floated in the presence of a depressant. The latter value is subtracted from the former; the difference is divided by the weight percent floated without any depressant; and this value is multiplied by 100 to obtain the percent of depression. In exemplary embodiments, the percent of depression may be any amount that will provide a necessary or desired amount of separation to enable separation of the desirable minerals from gangue. In exemplary embodiments, use of the exemplary depressant causes the flotation of desirable minerals to be depressed by at least about 5%, about 10%, or about 12%. In exemplary embodiments, use of the depressant causes the flotation of the gangue to be depressed by less than about 7.5% or about 5%.

Ore Processing

According to exemplary embodiments, a flotation process may use the exemplary hemicellulose or exemplary depressant compositions described herein. As discussed above, flotation is a commonly used process for separating or concentrating desirable minerals from ore, for example iron from taconite. Flotation processes take advantage of the differences between the hydrophobicity of the desired minerals and that of the gangue to achieve separation of these materials. Such differences can be increased with the use of surfactants and flotation agents, including but not limited to collecting agents and depressants (also called depressing agents).

Generally, a flotation process may include the steps of grinding crushed ore, classifying the ground ore in water, treating the classified ore by flotation to concentrate one or more minerals in the froth while the remainder of the minerals of the ore remain in the water pulp, and collecting the minerals in the froth and/or pulp. Some of these steps are described in more detail below.

In exemplary embodiments, a flotation process comprises separating the gangue from the desirable mineral concentrate by floating the gangue in the froth and recovering the desirable mineral concentrate as the underflow. In other exemplary embodiments, a flotation process comprises separating the gangue from the desirable mineral concentrate by inducing the gangue to sink to the bottom of the cell (as underflow) and recovering the desirable mineral concentrate as the overflow (froth). In exemplary embodiments, the flotation process comprises separating iron concentrates from silica and other silaceous materials by flotation of the silica and recovering the iron concentrate as underflow.

In exemplary embodiments, a process for enriching a desired mineral from an ore having the desired mineral and gangue includes carrying out a flotation process in the presence of one or more collecting agents and one or more exemplary hemicellulose or exemplary depressant compositions described herein.

In exemplary embodiments, the desired mineral is an iron-containing mineral, such as iron oxides or iron powder.

In exemplary embodiments, a process for enriching an iron-containing mineral from an ore having the iron-containing material and silicate-containing gangue, includes carrying out a flotation process in the presence of one or more collecting agents and one or more exemplary hemicellulose or exemplary depressant compositions described herein.

In exemplary embodiments, the flotation process is a reverse or inverted flotation process, for example a reverse cationic flotation process. In such processes, the flotation of the desired mineral is selectively depressed when compared to the flotation of the gangue so as to facilitate separation and recovery of the desired mineral.

In exemplary embodiments, the flotation process is a direct flotation process, for example a cationic or anionic flotation process.

In exemplary embodiments, the one or more depressants may be added at any stage of the process prior to the flotation step. In certain embodiments, the one or more depressants are added before or with the addition of the collecting agents.

In an exemplary process, various agents and modifiers may be added to the ore that is dispersed in water (flotation pulp), and air is introduced into the pulp to form a froth. The resulting froth contains those materials which are not wetted and have an affinity for air bubbles. Examples of such agents and modifiers include but are not limited to frothers, activators, collecting agents, depressants, dispersants, acidic or basic addition agents, or any other agent known in the art.

In exemplary embodiments, a collecting agent or collector may be added to the flotation pulp. Generally, collecting agents may form a hydrophobic layer on a given mineral surface in the flotation pulp, which facilitates attachment of the hydrophobic particles to air bubbles and recovery of such particles in the froth product. Any collecting agent may be used in the exemplary processes. The choice of collector may be determined, at least in part, on the particular ore to be processed and on the type of gangue to be removed. Suitable collecting agents will be known to those skilled in the art. In exemplary embodiments, the collecting agents may be compounds comprising anionic groups, cationic groups or non-ionic groups. In certain embodiments, the collecting agents are surfactants, i.e., substances containing hydrophilic and hydrophobic groups linked together. Certain characteristics of the collecting agent may be selected to provide a selectivity and performance, including solubility, critical micelle concentration and length of carbonic chain.

Exemplary collecting agents include compounds containing oxygen and nitrogen, for example compounds with amine groups. In exemplary embodiments, the collecting agents may be selected from the group consisting of: ether amines, for example primary ether monoamines, and primary ether polyamine; aliphatic C₈-C₂₀ amines for example aliphatic amines derived from various petroleum, animal and vegetable oils, octyl amine, decyl amine, dodecyl amine, tetradecyl amine, hexadecyl amine, octadecyl amine, octadecenyl amine and octadecadienyl amine; quaternary amines for example dodecyl trimethyl ammonium chloride, coco trimethyl ammonium chloride, and tallow trimethyl ammonium sulfate; diamines or mixed amines for example tallow amine, hydrogenated tallow amine, coconut oil or cocoamine, soybean oil or soya-amine, tall oil amine, rosin amine, tallow diamine, coco diamine, soya diamine or tall oil diamines and the like, and quaternary ammonium compounds derived from these amines; amido amines and imidazolines such as those derived from the reaction of an amine and a fatty acid; and combinations or mixtures thereof. In an exemplary embodiment, the collecting agent is an ether amine or mixture of ether amines.

Exemplary collecting agents may be partially or wholly neutralized by a mineral or organic acid such as hydrochloric acid or acetic acid. Such neutralization facilitates dispersibility in water. In the alternative, the amine may be used as a free base amine by dissolving it in a larger volume of a suitable organic solvent such as kerosene, pine oil, alcohol, and the like before use. These solvents sometimes have undesirable effects in flotation such as reducing flotation selectivity or producing uncontrollable frothing. Although these collecting agents differ in structure, they are similar in that they ionize in solution to give a positively charged organic ion.

According to the exemplary embodiments, the quantity of collecting agent may vary over a wide range. It may be determined, at least in part, on the desired result. The amount of collecting agent may vary. For example, it may be determined based upon, at least in part, the gangue content of the ore being processed. For example, ores having higher silica content may require greater quantities of collecting agents. In exemplary embodiments, about 0.01 to about 2 lbs., or about 0.1 to about 0.35 lbs., of collecting agent per ton of ore is used in the process.

In exemplary embodiments, one type of collecting agent is used in the process. In exemplary embodiments, two or more collecting agents are used in the process.

In exemplary embodiments, one or more frothing agents are used in the process. Exemplary frothing agents are heteropolar organic compounds which reduce surface tension by being absorbed at air-water interfaces and thus facilitate formation of bubbles and froth. Examples of frothing agents are methylisobutyl carbinol; alcohols having 6-12 carbon atoms which optionally are alkoxylated with ethylene oxide and/or propylene oxide; pine oil; cresylic acid; various alcohols and soaps. In exemplary embodiments, about 0.001 to 0.2 lb. of frothing agent per ton of ore are provided.

According to an exemplary embodiment, after completion of the flotation, a gangue-enriched flotate (froth), for example a silicate-enriched flotate, and a bottom fraction rich in the desired mineral (tailings, underflow), for example iron, are produced.

According to the embodiments, one or more steps may be done prior to the flotation step to prepare the ore for flotation. For example, in one step of the process, the ore can be ground, together with water, to the desired particle size, for example a particle size between about 5 and about 200 μm. Optionally, conditioning agents such as sodium hydroxide and/or sodium silicate may be added to the grinding mill prior to grinding the crude ore. In exemplary embodiment, sufficient water is added to the grinding mill to provide a slurry containing approximately 70% solids.

In exemplary processes, the ground ore may be deslimed. For example, the ground ore may be suspended in water, and fine material maybe deslimed, for instance, by filtration, settling, siphoning or centrifuging. In exemplary embodiments, the desliming step may be repeated one or more times.

In exemplary processes, an ore-water slurry may be prepared from the deslimed ore, and one or more depressants according to the embodiments may be added to the slurry. In exemplary embodiments, the one or more depressants are added in an amount of about 10 to about 1500 g per ton of ore. In exemplary embodiments, the ore-water slurry to transferred to a flotation cell and the one or more depressants are added to the ore water slurry in the flotation cell.

In exemplary embodiments, base or alkali may be added to adjust the pH of the slurry. For example, the slurry may be adjusted to a pH in the range of about 8 to about 11, or about 9 to about 11, or about 10 to about 11. In certain embodiments, the pH is adjusted to about 10.5. In exemplary embodiments, the pH of the slurry in the flotation cell is maintained at between about 8 and about 11 for optimum iron recoveries.

According to the embodiments, in one step of the flotation process, one or more collecting agents may be added, for example after the addition of the one or more depressants and any other process agents.

In exemplary embodiments, once all of the processing agents have been added, the mixture is further conditioned or agitated for a period of time before the froth flotation is carried out. If desired, a froth-regulating means can be added on a convenient occasion before the froth flotation.

In exemplary embodiments, the flotation process may be performed in a plurality of flotation processing steps. For example, the flotation process may be performed in flotation units containing a plurality of communicating cells in series, with the first cell(s) being used generally for the rougher flotation, and subsequent cell(s) being used for the cleaner flotation. In exemplary embodiments, each flotation cell may be any flotation equipment, including, for example, the Denver laboratory flotation machine and/or the Wemco Fagergren laboratory flotation machine, in which the slurry mixture is agitated and air is injected near the bottom of the cell as desired.

In exemplary embodiments, before flotation treatment the ore-water slurry comprises about 20 to about 40% by weight solids. The duration of the flotation process may be determined, for example, based on the desired result. In exemplary embodiments, the time of flotation treatment may be from about 1 to 10 minutes for each circuit. The time of the flotation process may vary. For example, it may be determined based on, at least in part, the gangue content, the grain size of the ore being treated and/or the number of flotation cells involved.

According to the embodiments, in the rougher flotation treatment, the gangue may be selectively separated from the ore and removed with the flotation froth. The desired mineral concentrate from the flotation treatment is removed as the underflow and isolated as the rougher concentrate. In exemplary embodiments, the concentrate of the desirable mineral in the rougher concentrate is found to contain a sufficiently low quantity of gangue to be suitable for almost any desired use.

In exemplary embodiments, the flotation froth, the rougher concentrate, or both may be further processed. For example, in exemplary embodiments, the overflow or froth from the rougher flotation may be advanced to a first cleaner flotation cell where a second flotation treatment is performed. The underflow from this first cleaning flotation cell is a mineral concentrate identified as the first cleaner middlings which generally will contain more gangue than the rougher concentrate but significantly less gangue than the original crude ore. The overflow frothing from the first cleaning cell may be advanced to a second cleaning flotation cell where the flotation procedure is repeated and another mineral concentrate is obtained which is identified as the second cleaner middlings. In exemplary embodiments, the froth flotation cleaning is repeated one or more times. Any or all of the cleaner middlings may be combined with a rougher concentrate to provide an upgraded mineral ore concentrate. The extent to which the rougher concentrate is combined with the various middling fractions may be determined, for example, based upon the desired mineral content of the final product derived from the procedure. As an alternative embodiment, the cleaner middlings may be returned and recycled through the rougher flotation cell to further upgrade these cleaner middlings.

The depressant compositions and processes described herein can be used to provide higher selectivity and desired mineral recoveries as compared to other depressants when used in flotation processes. In exemplary embodiments, the mineral concentrate, e.g., hematite concentrate, that is obtained by the exemplary processes meets the specifications for the steel industry. In exemplary embodiments, the depressant compositions and processes can be used to maximize the iron recovery to increase production of metallic charge per unit ore fed, which may provide increases in production and profitability.

The following examples are presented for illustrative purposes only, and are not intended to be limiting.

### Examples

### Example 1: Three-Stage Hemicellulose Extraction from Corn Fiber

Corn fiber samples were received as dry flakes, which were ground in a Vitamix Blender to 80% passing a 35 mesh (500 microns) screen.

In Stage 1 of the extraction, 300 g of dry corn fiber was made down to 10% consistency with (i) 85 kg NaOH per ton of dry corn fiber and (ii) 30 kg H₂O₂ per ton of dry corn fiber. The batch was processed at 80° C. for two hours with constant stirring at approximately 900 rpm. Separation was achieved with centrifuge at 15,300×g (about 10000 rpm for this instrument) for 30 minutes.

The solids, viscosity and specific gravity of the liquid product were evaluated. The organic solids were calculated as follows:

$$\begin{matrix}TS = \frac{{m}_{dry}}{{m}_{total}} \times 100 \% & ( 1 ) \\ IS = \frac{{m}_{ash}}{{m}_{total}} \times 100 \% & ( 2 ) \\ OS = TS - IS & ( 3 )\end{matrix}$$

TS is total solids (wt %); IS is the inorganic solid (wt %), OS is the organic solid (wt %); m_{dry} is the mass after 20 hour drying at 105° C. (g); mₜₒₜₐₗ is the starting wet mass (g); and mₐₛₕ is the mass after dried and ashed at 900° C. for 1 hour (g).

The percent extracted was calculated as follows:

$$\% extracted = \frac{{OSxm}_{H 2 Oi}}{{m}_{CF}} \qquad ( 4 )$$

m_{H2Oi} is the initial mass of H₂O in reaction (g); m_{CF} is the mass of dry corn fiber (g). The value determines the full hemicellulose amount that is able to be extracted from the corn fiber in each batch. The m_{H2Oi} takes into account all the water present in the reaction including the water in the corn fiber and the reagents.

After separation, a composition containing 5.54% hemicellulose (790 g hemicellulose) was obtained. The 5.54% hemicellulose composition was carried on and included in Stage 2 processing.

In Stage 2, 82 g dry corn fiber, 85 kg NaOH per ton of dry corn fiber and 30 kg H₂O₂ per ton of dry corn fiber were added. The batch was processed at 80° C. for two hours with constant stirring at approximately 900 rpm. Separation was achieved with centrifuge at 15,300×g for 30 minutes. The solids content was analyzed again, as in Stage 1. After separation, a composition containing 12.17% hemicellulose (430 g hemicellulose) was obtained. The 12.17% hemicellulose composition was carried on and included in Stage 3 processing.

In Stage 3, 50 g of dry corn fiber, 85 kg NaOH per ton of dry corn fiber and 30 kg H₂O₂ per ton of dry corn fiber were added. The batch was processed at 80° C. for two hours with constant stirring at approximately 900 rpm. Separation was achieved with centrifuge at 15,300×g for 30 minutes. The solids content was analyzed again. After separation, a composition containing 18.25% hemicellulose was obtained.

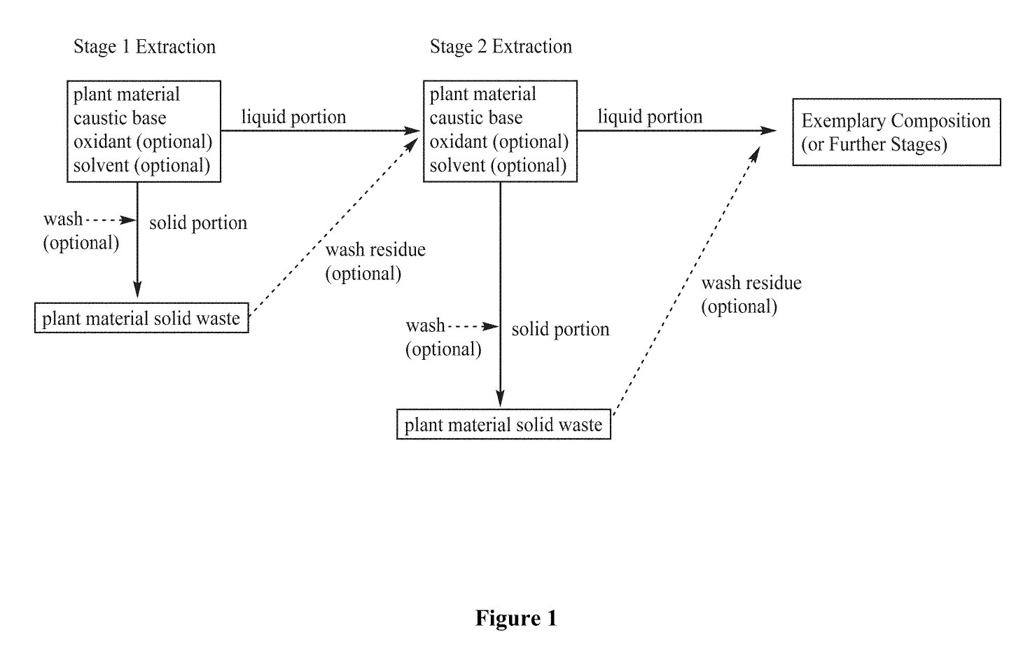

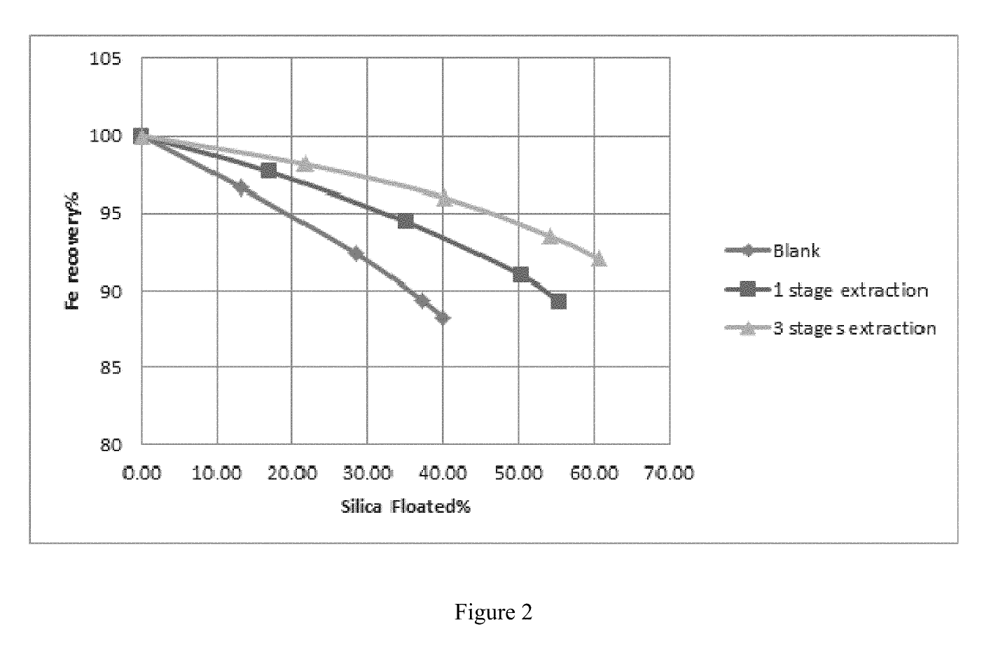

An illustration of the three-stage extraction is provided in FIG. 1. In this figure, “Hem” refers to “hemicellulose,” “Ext” refers to “extracted,” “Ret” refers to “retained” and “CFR” refers to “corn fiber residue”. Each stage resulted in approximately the same percent increase in organic solids. However, the percent extracted hemicellulose decreased for each step. The amount of hemicellulose lost to waste increased from approximately 32% for the first two stages to approximately 50% for the last stage. This decrease in solid may relate to the increase in sugar content in the solution, which causes the product to stick to the corn fiber waste. The loss of product can be mitigated by including an additional washing and filtering stage to the waste material of each extraction stage, as illustrated in FIG. 2.

### Example 2: Physical Properties of Hemicellulose Composition

The viscosity of the product in Stage 1 of Example 1 was 30 cP. As the solids increased, the viscosity increased exponentially (Table 1). The specific gravity correlated with the percent solids in the samples.

TABLE 1

| Property | Stage 1 | Stage 2 | Stage 3 |
|---|---|---|---|
| Organic Solids | 6.54% | 12.17% | 18.26% |
| Viscosity (cP) | 30 | 220 | 3350 |
| Density (lb/gal) | 8.590 | 8.838 | 9.073 |
| Specific Gravity | 1.0310 | 1.0606 | 1.0888 |
| pH | 10.30 | 10.38 | 10.23 |

### Example 3: Flotation Testing

A representative 1 L sample or iron ore was split from a mixed 5-gallon bucket. The solids were adjusted to 30% w/w prior to testing. Floatation tests were contacted in a 1 L Metso laboratory floatation cell. The depressant (a hemicellulose composition prepared according to Example 1) was diluted to 1 wt % solution. The collector solution of amine (Tomamine DA-16) and frother solution (MIBC) were also prepared to 1% wt %.

The depressant, collector and frother were dosed at 1500 g/ton, 175 g/ton and 60 g/ton, respectively, with no pH adjustment. A baseline test with no depressant was also conducted. For each test, the slurry was constantly agitated at 800 rpm. Depressant was added and conditioned for five minutes, then the collector and frother were added simultaneously and air was introduced to the agitated slurry. The floatation fractions were collected at 0.5, 1, 2 and 3-minute intervals. The four tail fractions and concentrate were dried in a convection oven until the weight change was 0.00±0.02 g. The samples were analyzed by X-ray fluorescence (XRF, Bruker Explorer S4) for mineral content. The initial feed concentrations were calculated based on the total mineral content of each fraction.

The results of the flotation test are provided in Table 2 and illustrated in FIG. 2. Overall, adding a hemicellulose depressant provided better separation compared to the baseline test. The depressant corresponding to the hemicellulose composition from Stage 1 extraction resulted in SiO₂ Rej %/Fe Loss % of 5.19. The SiO₂ Rej %/Fe Loss % indicates the amount of silica in the froth relative to the amount of silica in the initial flotation feed divided by the amount of iron in the froth relative to the amount of iron in the initial flotation feed. The exemplary depressant, corresponding to the hemicellulose composition from Stage 3, showed better performance (SiO₂ Rej %/Fe Loss % of 7.60).

TABLE 2

| | | Mass | Fe | Fe Grade | SiO₂ Grade | | SiO₂ Grade | SiO₂ Rej %/ |
|---|---|---|---|---|---|---|---|---|
| | | Recovery | Recovery | in. Conc. | in Conc. | Fe Grade | in Tails | Fe Loss |
| Sample | Description | (%) | (%) | (%) | (%) | in Tails | (%) | % |
| 1 | Stage 1 | 86.40 | 89.30 | 66.36 | 3.17 | 50.51 | 25.08 | 5.19 |
| | hemicellulose | | | | | | | |
| | (~7%) | | | | | | | |
| 2 | Stage 3 | 88.87 | 92.03 | 66.99 | 2.55 | 46.29 | 31.23 | 7.60 |
| | hemicellulose | | | | | | | |
| | (~18%) | | | | | | | |
| 3 | Baseline | 86.20 | 88.19 | 64.68 | 4.30 | 54.08 | 18.03 | 3.40 |
| | (blank) | | | | | | | |

In the preceding procedures, various steps have been described. It will, however, be evident that various modifications and changes may be made thereto, and additional procedures may be implemented, without departing from the broader scope of the exemplary procedures as set forth in the claims that follow.

We claim:

1. A method for preparing a hemicellulose composition or a depressant composition comprising hemicellulose, comprising:
(a) combining new or undigested plant material comprising hemicellulose, at least one caustic base and, optionally, at least one oxidant to form a first reaction mixture;
(b) reacting the first reaction mixture for a time sufficient to form a first reaction product containing hemicellulose, wherein the reaction product comprises a liquid portion and solid portion;
(c) separating at least some of the liquid portion of the first reaction product from the solid portion of the first reaction product to provide a first hemicellulose composition;
(d) combining at least a portion of the first hemicellulose composition with new or undigested plant material, at least one caustic base and, optionally, at least one oxidant to form a second reaction mixture,
(e) reacting the second reaction mixture for a time sufficient to form a second reaction product containing hemicellulose, wherein the reaction product comprises a liquid portion and a solid portion; and
(f) separating at least some of the liquid portion of the second reaction product from the solid portion of the second reaction product to provide a second hemicellulose composition or depressant composition comprising hemicellulose.

2. The method of claim 1, wherein the method further comprises:
(g) combining at least a portion of the second hemicellulose composition with new or undigested plant material, at least one caustic base and, optionally, at least one oxidant to form a third reaction mixture,
(h) reacting the third reaction reacting mixture for a time sufficient to form a third reaction product containing hemicellulose; wherein the reaction product comprises a liquid portion and solid portion; and
(i) separating at least some of the liquid portion of the third reaction product from the solid portion of the third reaction product to provide a third hemicellulose composition or a depressant composition comprising hemicellulose.

3. The method of claim 2, wherein the method further comprises:
(j) combining at least a portion of the third hemicellulose composition with new or undigested plant material, at least one caustic base and, optionally, at least one oxidant to form a fourth reaction mixture,
(k) reacting the fourth reaction reacting mixture for a time sufficient to form a fourth reaction product containing hemicellulose; wherein the reaction product comprises a liquid portion and solid portion; and
(l) separating at least some of the liquid portion of the fourth reaction product from the solid portion of the fourth reaction product to provide a fourth hemicellulose composition or a depressant composition comprising hemicellulose.

4. The method of claim 3, wherein the new or undigested plant material in steps (a), (d), (g) and/or (j) comprises lignocellulosic biomass.

5. The method of claim 4, wherein the lignocellulosic biomass is derived from an agricultural residue, hardwoods or herbaceous crops.

6. The method of claim 3, wherein the new or undigested plant material in steps (a), (d), (g) and/or (j) is corn fiber.

7. The method of claim 3, wherein the plant material consistency % in steps (a), (d), (g) and (j) is from about 5% to about 50%.

8. The method of claim 3, wherein the caustic base in each of steps (a), (d), (g) and/or (j) is independently selected from sodium hydroxide, calcium hydroxide, potassium hydroxide, lithium hydroxide, rubidium hydroxide, cesium hydroxide, magnesium hydroxide, strontium hydroxide, barium hydroxide, calcium hydroxide, a hydrate thereof, an oxide thereof, or a combination thereof.

9. The method of claim 3, wherein at least one oxidant is added in each of steps (a), (d), (g) and/or (j).

10. The method of claim 3, wherein the at least one oxidant added in each of steps (a), (d), (g) and/or (j) is a peroxide.

11. The method of claim 3, wherein at least one of steps (b), (e), (h) and (k) further comprises heating the reaction mixture.

12. The method of claim 11, wherein the reaction mixture in at least one of steps (b), (e), (h) and (k) is heated at a temperature from about 25° C. to about 130° C.

13. The method of claim 11, wherein the reaction mixture in at least one of steps (b), (e), (h) and (k) is heated for about 15 minutes to about 36 hours.

14. The method of claim 3, wherein at least one of steps (b), (e), (h) and (k) further comprises mixing, stirring, agitating or sonicating the reaction mixture.

15. The method of claim 1, wherein the first hemicellulose composition in step (c) contains from about 2 to about 10 wt % organic solids.

16. The method of claim 1, wherein the second hemicellulose composition, or the depressant composition, in step (f) contains from about 4 to about 15 wt % organic solids.

17. The method of claim 2, wherein the third hemicellulose composition, or the depressant composition, in step (i) contains from about 6 to about 30 wt % organic solids.

18. The method of claim 3, wherein the fourth hemicellulose composition, or the depressant composition, in step (l) contains from about 8 to about 30 wt % organic solids.

19. The method of claim 3, wherein steps (d), (g), and (j) could be accomplished by recycling the hemicellulose composition in whole or in part.

20. The method of claim 2, further comprising washing the solid portion of the reaction product in steps (c) and/or (f) with water to provide a hemicellulose wash composition.

21. The method of claim 20, wherein at least a portion of the hemicellulose wash composition is combined with the hemicellulose composition, new or undigested plant material, at least one caustic base and, optionally, at least one oxidant in steps (d) and/or (g).

22. The method of claim 2, wherein the third hemicellulose composition in step (i) contains at least about 21 wt % hemicellulose.

23. A hemicellulose composition prepared according to the method of claim 1.

24. The hemicellulose composition of claim 23, wherein the weight average molecular weight of the hemicellulose in the organic solids composition is from about 100 kDa to about 600 kDa.

25. A hemicellulose composition comprising at least about 20 wt % organic solids including hemicellulose, lignin, fatty acids and proteins, and a solvent, wherein the weight average molecular weight of the hemicellulose in the composition is from about 100 kDa to about 600 kDa.

26. The composition of claim 25, wherein the solvent comprises water.

27. The composition of claim 25, wherein the hemicellulose is derived from corn fiber.

28. A process for enriching a desired mineral from an ore comprising the desired mineral and gangue, wherein the process comprises carrying out a flotation process in the presence of one or more collecting agents and one or more depressants, wherein at least one of the one or more depressants comprises a hemicellulose composition according to claim 23.

29. A process for enriching a desired mineral from an ore comprising the desired mineral and gangue, wherein the process comprises carrying out a flotation process in the presence of one or more collecting agents and one or more depressants, wherein at least one of the one or more depressants comprises a hemicellulose composition comprising at least about 20 wt % organic solids including hemicellulose, lignin, fatty acids and proteins, wherein the weight average molecular weight of the hemicellulose in the depressant composition is from about 100 kDa to about 600 kDa.

30. The process of claim 28, wherein the desired mineral is an iron-containing mineral.

31. The process of claim 28, wherein the gangue comprises oxides of silica, silicates or siliceous materials.

32. The process of claim 28, wherein the flotation process is a reverse cationic flotation process.

33. The process of claim 28, wherein the composition comprises a solvent.

34. The process of claim 33, wherein the solvent is water.
